(19) United States
(12) Patent Application Publication
(10) Pub. No.: US 2007/0143297 A1
(43) Pub. Date: Jun. 21, 2007

(54) Extended digital information retrieval for wireless devices

(76) Inventors: Renato J. Recio, Austin, TX (US); Joanne M. Santiago, Cedar Park, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/304,954

(22) Filed: Dec. 15, 2005

(51) Int. Cl. G06F 17/30

(52) U.S. Cl. 707/10

(57) ABSTRACT

A method and implementing system are provided for enabling a wireless device to access a remote server service containing an extended information database in digital form. In an exemplary embodiment, a user is provided with the ability to retrieve and store entries using a cell or other wireless device from a service provider database, and store the retrieved extended information in the user's wireless device memory. A user is enabled to specify a type of information desired for a given GPS location or address. Requested extended digital information is transmitted from a remote server database to a requesting caller's wireless device and stored in the device memory. For dynamic digital information that is continuously changing, a user is enabled to request a continuous and/or periodic updating of the requested information. When updated information is received, or when a user is within a predetermined distance from a specified type of enterprise, an audible or other perceptible signal is produced at the user's wireless device.

### FIELD OF THE INVENTION

The present invention relates generally to information processing systems and more particularly to a methodology and implementation for accessing and updating digital information for wireless devices.

### RELATED APPLICATIONS

Subject matter disclosed but not claimed herein is disclosed and claimed in co-pending application 05-0621, which is included herein by reference.

### BACKGROUND OF THE INVENTION

Global Positioning System or GPS is a technology for assigning a geographic location to a device or a location on the earth. A GPS receiver on the surface of the earth communicates with a set of GPS satellites orbiting the earth to derive an accurate position. GPS receivers have become very inexpensive and are being designed into more and more personal computing devices including personal digital assistant (PDA) devices as well as laptop computers, automobile navigation systems and other wireless devices.

Existing GPS software provides users only very limited information about a queried GPS location. This limitation of information requires a user of a GPS-enabled device to depend on other sources, and other devices, for more or extended information about a specific location.

Thus, there is a need for an improved methodology and system for providing access to, and local storage for, extended location-related information received from a location-based information system using a wireless phone-enabled device.

### SUMMARY OF THE INVENTION

A method and implementing system are provided for enabling a phone-enabled wireless device to access a remote server service containing an extended information database in digital form. In an exemplary embodiment, a user is provided with the ability to retrieve and store entries using a cell or other wireless device from a service provider database, and store the retrieved extended information in the user's wireless device memory. A user is enabled to specify a type of information desired for a given area or GPS location. Requested extended digital information related to an input address or GPS location is transmitted from a remote server database to a requesting caller's wireless device and stored in the device memory. Routing from a user's location to an input destination may be calculated at server and transmitted to the user's wireless device or calculated by the wireless device after receiving GPS of the destination from the server. In either case, the user is enabled to receive the navigation information as a GPS on-road navigation map or as text step-by-step directions. When a user passes by or is in certain proximity to a target, e.g. a specified restaurant that matches the input criteria, then an alarm may be sounded to alert the user to the fact that a desired restaurant is nearby. Dynamic updates of the requested extended information are available and the user is alerted upon receipt of updated information.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing an overall communication system in which the present invention may be implemented;

FIGS. 2 is a block diagram illustrating several of the components within a wireless communication device used in one exemplary implementation of the present invention;

FIG. 3 is an illustration of a screen display which may be used in connection with the present invention;

FIG. 4 is an illustration of an exemplary Extended Information menu;

FIG. 5 is an illustration of an exemplary Search Criteria menu;

FIG. 6 is an illustration of an display screen which may be implemented during an exemplary operation of the present invention; and

FIG. 7 is a flowchart illustrating an exemplary operational sequence of the extended information search and retrieval process implemented in accordance with the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. Although the present invention is herein disclosed using a cellular wireless communication device in the example, it is understood that the invention applies equally as well to wireless communication devices of all kinds including, but not limited to Personal Digital Assistant (PDA) devices, wireless computers and wireless phones using other than cellular technologies, and also to other satellite and cellular applications including but not limited to vehicle navigation systems.

This disclosure describes a digital mechanism that allows users to store in the memory of a phone-enabled wireless device, GPS or location-related data which have been retrieved in accordance with a user request. In an example, a user may specify types of businesses in which the user is interested through input to a user wireless device in a moving vehicle. The GPS of the user is transmitted to an information service and whenever the user comes within a predetermined distance of any specified business type, a detailed data record related to the business is downloaded to the user and an alarm is sounded to alert the user that an item of interest is within a predetermined range of the user's vehicle or wireless phone. The user may then call the business or request directions or review other detailed information that was downloaded to the user's wireless device. The user also has the option to store the downloaded information or have it replaced with information from another subsequently encountered business type. In another mode, a user may enter a remote GPS location into the search request and specified businesses within a predetermined range of the specified GPS location, along with extended detailed data regarding the business, will be downloaded and displayed to the user. Remote GPS location identities are may be determined by inputting an address or zip code for example, and a directory information service provider will return a record related to the input address which will include the GPS location of the input address.

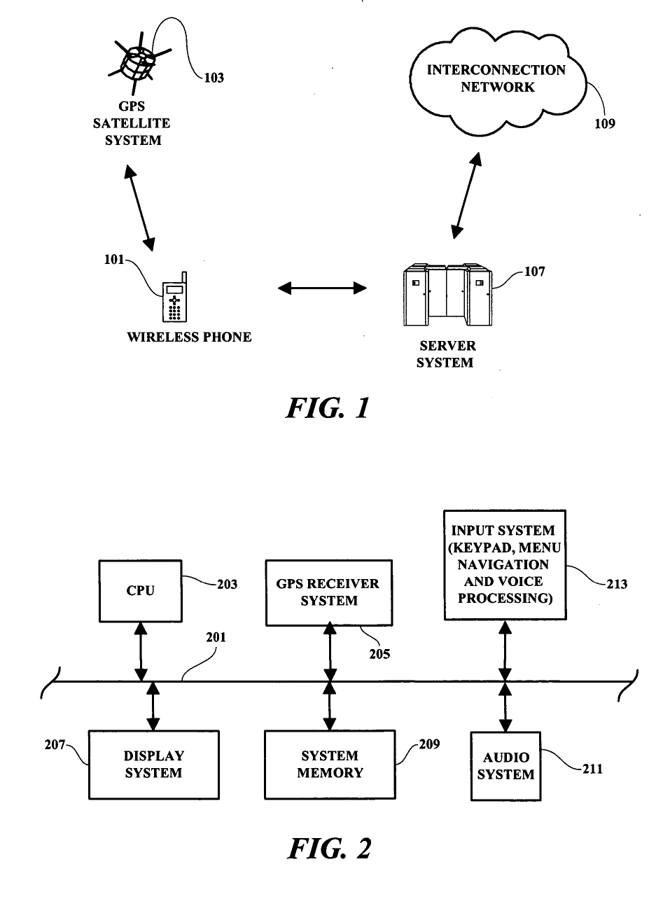

As shown in FIG. 1, an exemplary communication network includes a wireless phone 101 (which may be any wireless phone-enabled device) which is operable to receive GPS location signals from a GPS satellite system 103 typically consisting of a group of three satellites. The wireless phone 101 is operable to transmit to and receive signals from a cellular service provider's base server system 107. The server, in turn, is operable to be connected through an interconnection network 109 such as the Internet, to other servers for information access and retrieval as necessary. The server system 107 also may include a GPS object associated to each address that may be used in GPS navigation enabled devices, where the GPS object may contain but is not limited to, the GPS coordinates of the location.

For example, the server 107 may be accessed with a known location name or a known address and information including the GPS coordinates of the input address will be returned and displayed or saved on the user's wireless device. In a current search mode, the GPS coordinates of the user's wireless device are continuously transmitted to the server system and the server system is able to compare the received coordinates and criteria specified by the user with criteria of business within a predetermined radius of the user's current GPS position and alert the user when the user is located close to a specified search object.

As shown in FIG. 2, the wireless phone 101 includes, among other components, a main bus 201 to which is connected a CPU unit 203, a GPS receiver system 205, a display system 207, a system memory 209 and an audio system 211. Also connected to the main bus 201 is an input unit 213 which includes a keypad system for enabling user keypad input, a wireless telephone menu navigation system for enabling navigation through selection menus presented on the display screen of the phone, and voice processing circuitry for translating voiced input into digital signals.

Additionally, in a digital mode, the cellular phone 101 is used to call a “411” number for example, to request the address and or telephone number for a person at a given address. This information is given verbally to an operator and in response, either the operator or a voicing machine, provides the telephone number or address requested in verbal format to the caller. The caller may also request to have the phone number and corresponding GPS data, which may include the address and the GPS coordinates, sent to the caller's cell phone. This process saves the caller from incurring an extra expense to have the number dialed by the operator or manually entering the address into the cell phone. It also saves the information in the caller's directory without requiring the caller to write down the information and then enter the information separately into the caller's library or directory.

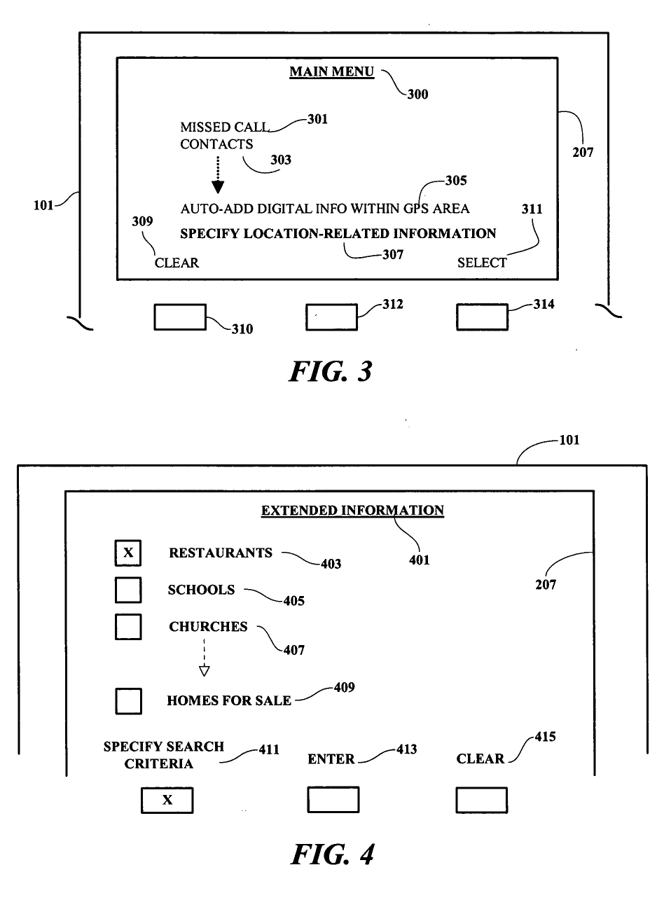

FIG. 3 shows the display area 207 of a cellular phone 101. Display area 207 may also be the display area associated with an in-vehicle navigation system. A Main Menu 300 is displayed which includes several categorical headings including “Missed Call” 301 and “Contacts” 303. The Main Menu also includes selection icons for “Auto-add Digital Information” 305 and “Specify Location-Related Information” 307. The menu also shows a CLEAR function 309 for returning to a home page, and a SELECT icon 311 which may be selected to actuate a highlighted sub-menu or other operation. Several selection buttons 310, 312 and 314 are also shown below the display area 207. The selection button 314 is operable when depressed to select a menu item which has been highlighted by a user. For example, as shown, the menu item SPECIFY LOCATION-RELATED INFORMATION 307 has been highlighted by the user and a depression of selection button 314 will cause the display illustrated in FIG. 4 to be presented on the user's wireless device.

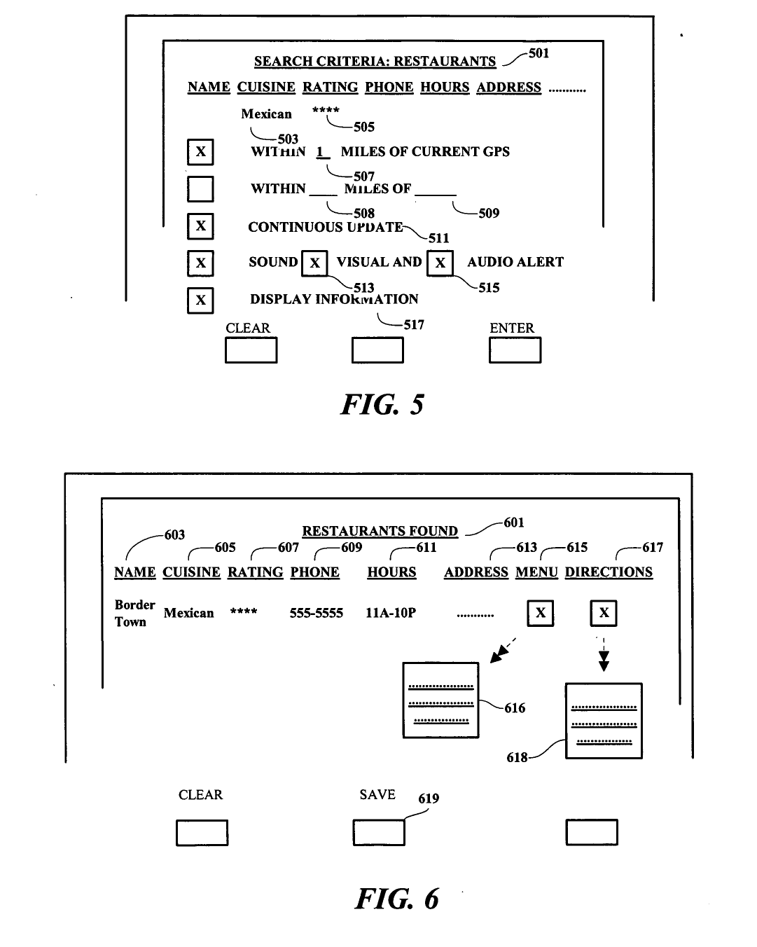

As shown in FIG. 4, an “EXTENDED INFORMATION” menu 401 enables a user to select a type of enterprise, for example, a business or type of institution in which the user is interested. For example, the user may select Restaurants 403, Schools 405, Churches 407 or Homes For Sale 409 as well as other categories not specifically listed in the example. As shown, the user has selected Restaurants as a type of business in which the user is interested. In other words, the user may be planning a trip through a neighborhood and wishes to know what restaurants are in the area through which the user is traveling. After selecting Restaurants 403, if the user wishes to obtain extended information or narrow his or her search regarding restaurants in the area, the user will select the SPECIFY SEARCH CRITERIA option 411 and a screen such as the example shown in FIG. 5 will be presented.

As shown in FIG. 5, a search criteria menu 501 enables a user to further specify certain search criteria 501 with regard to restaurants in the area. In the example, the user is particularly interested in Mexican restaurants 503 in the area that have at least a four star rating 505. Further, the user wishes to know all such restaurants within a one mile radius 507 of the user's current position at any given time. The user may also specify a different radius 508 or a different GPS 509. The user then selects to have this search continuously updated 511 during the user's journey and whether the user wishes to have an visual alert 513 (such as a flashing screen) and/or an audio alert 515 and an information display when a specified business, e. g. a four star Mexican Restaurant, is within the predetermined range from the user's current position. When the above specification is entered, the user may return to the menu shown in FIG. 4 to specify other types of businesses or institutions in a similar manner. When all of the search information has been entered and sent to the server 107, the server 107 accesses an extended information database of businesses and institutions and attempts to match the input specification to corresponding specifications of businesses and institutions in the area. The search will key in on the user's current GPS coordinates which are continuously transmitted from the user's GPS-enabled wireless device to the server system 107. When a match has been found by the server 107, a sound and visual alert will be provided (if selected by the user) at the user's device 101, and the extended information data record will be downloaded and sent to the user's display.

As shown in FIG. 6, the downloaded record for restaurants 601 includes, for example, the name of the restaurant 603, the type of cuisine 605, the rating 607, the phone number 609, the hours of operation 611, the address 613, the menu icon 615 and even a directions icon 617. If the menu icon is selected 615, a menu is presented 616 in a full screen format for the user to peruse. If the directions icon is selected 617, directions to the identified restaurant are provided 618. The user is also given the option to save 619 the record for the restaurant in the memory 209 of the user's wireless device 101. The display will continue to present extended information records for additional restaurants and/or other businesses or institutions specified by the user as the user enters within the specified radius from such businesses or institutions during the user's journey. Routing from a user's location to an input destination may be calculated at server and transmitted to the user's wireless device or calculated by the wireless device after receiving GPS of the destination from the server. In either case, the user is enabled to receive the navigation information as a GPS on-road navigation map or as text step-by-step directions.

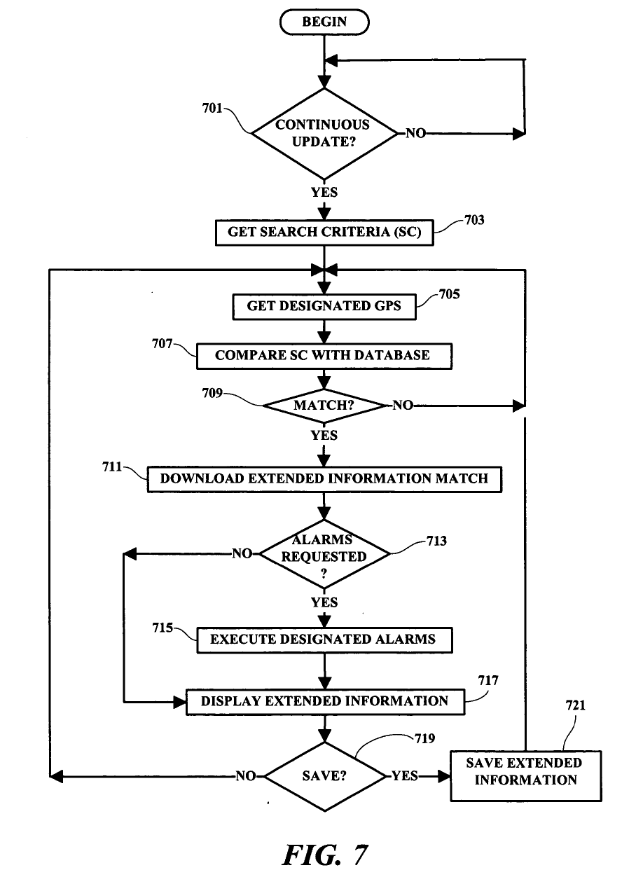

In the FIG. 7 flowchart, the processing begins by determining that a continuous update 701 has been selected by the user. The search criteria specified by the user will be fetched 703 and the current GPS location coordinates for the user's wireless device will be continuously received 705. The search criteria and the current GPS is compared 707 with available server database information and when there is a match 709, the extended information record associated with the specified and located business or institution is downloaded 711 to the user's device. If the user requested alarms 713, the designated alarms will be executed 715 at the user's device 101 and the extended information record will be presented 717 on the user's display 207. If the user wishes to save 719 the extended information record for the found restaurant, the record is saved to the user's memory 209 and the processing continues to monitor the user's current GPS position 705 and continue the database search for the user-specified businesses and/or other institutions. When a user passes by or is in certain proximity to a target, e.g. a specified restaurant that matches the input criteria, then an alarm may be sounded to alert the user to the fact that a desired restaurant is nearby. Target GPS information or navigation information from the user's current position to the restaurant may be downloaded automatically when a proximity to the restaurant is detected. Alternately, the navigation information may be downloaded to the user's device or calculated by the user's device only upon user request.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a storage medium from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for obtaining extended digital information related to enterprises within a predetermined radius of a designated GPS location, said method comprising:
enabling a user of a wireless device to select an enterprise type for which said user desires said extended digital information;
enabling said user to transmit said enterprise type to a server system;
searching extended information databases by said server system to find said enterprise type within a predetermined area related to a location specified by said user; and
transmitting search results information from said server system to said wireless device regarding search results obtained by said server system.

2. The method as set forth in claim 1 wherein said search result information includes extended digital information relating to said enterprise type for enterprise types located within a predetermined distance from said GPS location of said user.

3. The method as set forth in claim 2 and further including enabling said user to select and transmit said predetermined distance from said wireless device to said server system.

4. The method as set forth in claim 1 and further including saving said search result information in a memory unit within said wireless device.

5. The method as set forth in claim 4 wherein said memory unit is a non-volatile memory unit.

6. The method as set forth in claim 1 and further including enabling said user to select to save said search result information in a memory unit within said wireless device.

7. The method as set forth in claim 6 wherein said memory unit is a non-volatile memory unit.

8. The method as set forth in claim 1 wherein said wireless device is a GPS-enabled device.

9. The method as set forth in claim 8 wherein said wireless device is also a phone-enabled device.

10. The method as set forth in claim 1 and further including enabling said user to transmit a GPS location different from a current GPS location of said wireless device.

11. The method as set forth in claim 1 wherein said wireless device is a GPS-enabled wireless device, wherein a current GPS location of said wireless device is continually transmitted from said wireless device to said server system, said server system being enabled to update said searching with said current GPS location in conducting said searching.

12. The method as set forth in claim 1 and further including displaying said search results on a display of said wireless device.

13. The method as set forth in claim 1 wherein said wireless device is enabled for providing a perceptible alarm upon receipt of said search results.

14. The method as set forth in claim 13 wherein said wireless device is enabled for providing a perceptible alarm upon detection that said wireless device is within said predetermined area.

15. The method as set forth in claim 13 wherein said perceptible alarm is an audio or visual alarm.

16. The method as set forth in claim 13 and further including enabling said user to select a type of said perceptible alarm.

17. The method as set forth in claim 3 wherein said GPS location is a current location of said wireless device.

18. The method as set forth in claim 3 wherein said GPS location is a location different from a current location of said GPS device.

19. A wireless device comprising:
a main bus;
a processing unit coupled to said main bus;
a memory unit coupled to said main bus;
a GPS receiver coupled to said main bus;
a display unit coupled to said main bus;
input means for enabling user input to said wireless device;
means for enabling a user of said wireless device to select an enterprise type for which said user desires to receive extended digital information;
means for enabling said user to transmit said enterprise type and a GPS location or address to a server system, said server system being enabled for searching extended information databases to find said enterprise type within an area related to said GPS location or address ; and
means for transmitting search results information from said server system to said wireless device regarding search results obtained by said server system.

20. A programmed medium within a wireless GPS-enabled device, said programmed medium being selectively accessible to provide program signals operable for enabling said wireless GPS-enabled device to obtain extended digital information related to enterprises within a predetermined radius of a designated GPS location, said program signals being operable for:
enabling a user of a wireless device to select an enterprise type for which said user desires said extended digital information;
enabling said user to transmit said enterprise type and a GPS location or address to a server system;
searching extended information databases by said server system to find said enterprise type within an area related to said GPS location or address; and
transmitting search results information from said server system to said wireless device regarding search results obtained by said server system.
